(19) United States
(12) Patent Application Publication
(10) Pub. No.: US 2015/0027397 A1
(43) Pub. Date: Jan. 29, 2015

(54) ROLLING BEARING AND INTERNAL COMBUSTION ENGINE EQUIPPED WITH SUCH A ROLLING BEARING

(71) Applicants: Richard Corbett, FONDETTES (FR); Julien Maffucci, Pernay (FR)

(72) Inventors: Richard Corbett, FONDETTES (FR); Julien Maffucci, Pernay (FR)

(73) Assignee: Aktiebolaget SKF, Goteborg (SE)

(21) Appl. No.: 14/444,313

(22) Filed: Jul. 28, 2014

(30) Foreign Application Priority Data
Jul. 26, 2013 (FR) 1357394

(51) Int. Cl. F16C 33/62; F16F 15/32

(52) U.S. Cl. CPC F16C 33/62; F16F 15/322
USPC 123/192.2; 384/492; 384/464

(57) ABSTRACT

The invention relates to a rolling bearing provided with at least one row of rolling elements disposed between an inner raceway and an outer raceway. At least one of the raceways is coated with a tungsten sulphide (WS₂) coating. The invention also relates to an internal combustion engine (M) having at least one balance shaft rotated by a crankshaft of the internal combustion engine (M), the at least one balance shaft being freely supported in rotation in a frame (B) of the internal combustion engine (M) by at least one such rolling bearing.

### CROSS-REFERENCE TO RELATED APPLICATIONS

This application claims priority to French Application No. 1357394 filed on Jul. 26, 2013, the contents of which are herein fully incorporated by reference.

### FIELD OF THE INVENTION

The present invention relates to a rolling bearing, in particular for an internal combustion engine comprising at least one balance shaft.

### BACKGROUND OF THE INVENTION

Internal combustion engines may comprise balancing systems which make it possible to compensate for the vibrations of the engine due to the movement of the pistons. An internal combustion engine sometimes comprises a single balance shaft, but more generally two balance shafts rotated in phase opposition by a toothed wheel of the crankshaft of the internal combustion engine. The balance shafts generally comprise at least one eccentric mass, which gives rise to radial and axial loads which increase with the rotational speed of the balance shafts.

The balance shafts are generally mounted in supports of the internal combustion engine via rolling bearings in which raceways for balls, needles or rollers are defined. It is known in particular from US-A-2011/0247581 to equip the balance shafts with rolling bearings having a single row of balls.

Advantageously, the rolling bearings are lubricated by a lubricating oil of the internal combustion engine, or are immersed in the said oil, an oil film forming between the rolling elements and the raceways.

However, the oil used has a particularly low viscosity. By virtue of this extreme fluidity, the oil film may disappear and the rolling elements are in direct metal-metal type contact against the raceways. This may result in the formation of metal particles forming a contamination of the internal combustion engine oil and a surface fatigue leading to a reduction in the life of the elements making up the rolling bearings.

These are the problems which the invention is most particularly intended to address by proposing a new rolling bearing, used in particular for an internal combustion engine comprising at least one balance shaft, having improved lubrication.

Accordingly, the invention relates to a rolling bearing provided with at least one row of rolling elements between an inner raceway and an outer raceway.

According to the invention, at least one of the said raceways of the rolling bearing is coated with a tungsten sulphide (WS₂) coating.

Tungsten sulphide (WS₂) is a solid lubricant which, in spite of its solid phase state, is capable of reducing the friction between two surfaces which slide against one another without requiring a large amount of lubricant.

Another feature is the presence of microcavities on and in the tungsten sulphide (WS₂) coating which, in the present invention, serve as a lubricant reservoir. Specifically, a certain amount of low-viscosity lubricant may be stored in the said microcavities.

By virtue of the invention, in the event of the disappearance of the lubricant film between the rolling elements and a raceway against which they are in frictional contact, the lubricant stored in the microcavities of the tungsten sulphide (WS₂) coating provides lubrication between the surfaces of the rolling elements and of the raceway which are in relative sliding contact.

A direct metallic contact between the rolling elements and the raceway is thus prevented, making it possible to increase the life of these elements and to prevent contamination of the environment in which they are mounted by metallic particles.

According to aspects of the invention which are advantageous but not obligatory, such a rolling bearing may incorporate one or more of the following features taken in any technically feasible combination:
The rolling elements of the rolling bearing are balls.
The rolling elements are rollers or needles.
The rolling elements of the rolling bearing are maintained with a more or less regular circumferential spacing by a cage.
The rolling bearing comprises an outer ring provided with a substantially cylindrical inner bore comprising at least one raceway for the rolling elements.
The rolling bearing comprises an inner ring provided with a substantially cylindrical outer surface comprising at least one raceway for the rolling elements.
The rolling bearing is such that the inner raceway and the outer raceway of the rolling bearing for at least one row of rolling elements are both covered with a tungsten sulphide (WS₂) coating.
At least one raceway for the rolling elements is a concave hollow of essentially toric shape.
The rolling bearing is immersed in lubricant.
The rolling bearing comprises seals which delimit a bearing chamber in which the rolling elements of this rolling bearing are placed, the said bearing chamber being completely or partly filled with lubricant.
The rolling bearing is an oblique-contact rolling bearing.
The rolling bearing is a radial-contact rolling bearing.
The tungsten sulphide (WS₂) coating of at least one raceway is formed by crystals of tungsten sulphide (WS₂), otherwise known as tungsten disulphide.
The crystals of the tungsten sulphide (WS₂) coating have a crystalline diameter of between 0.8 and 1.5 μm and a thickness of at most 100 nm.
The thickness of the tungsten sulphide (WS2) coating is between 0.5 et 0.8 μm.

The invention also relates to an internal combustion engine comprising at least one balance shaft rotated by a crankshaft of the internal combustion engine, the said at least one balance shaft being freely supported in rotation in a frame of the internal combustion engine by at least one rolling bearing according to one of the embodiments mentioned above.

According to aspects of the invention which are advantageous but not obligatory, such an internal combustion engine may incorporate one or more of the following features taken in any technically feasible combination:
The at least one rolling bearing comprises an outer ring mounted fixedly in the frame of the internal combustion engine, the said outer ring being provided with a substantially cylindrical inner bore comprising at least one raceway for the rolling elements.
The at least one rolling bearing comprises an inner ring mounted on a balance shaft, the said inner ring being provided with a substantially cylindrical outer surface comprising at least one raceway for the rolling elements.
The at least one balance shaft is provided with an outer surface of which a portion is substantially cylindrical and comprises at least one raceway for the rolling elements of the at least one rolling bearing.
The internal combustion engine comprises a follower pinion interposed between a toothed wheel of the crankshaft and a toothed wheel of the said at least one balance shaft.
The internal combustion engine comprises two balance shafts, a reversing pinion interposed between a toothed wheel of the crankshaft and a toothed wheel of one of the balance shafts, and the rotation of the reversing pinion is permitted by at least one rolling bearing having at least one row of rolling elements.

### BRIEF DESCRIPTION OF THE DRAWINGS

The invention will be better understood and other advantages thereof will become more clearly apparent in the light of the following description of two embodiments of an internal combustion engine according to its principle, given purely by way of example and with reference to the appended drawings, in which:

FIG. 1 is a view in section of an internal combustion engine according to the invention, according to a first embodiment;

FIG. 2 is a larger-scale view of the detail II in FIG. 1 according to this first embodiment; and

FIG. 3 is a larger-scale view of the same detail II in FIG. 1 but according to a second embodiment.

### DETAILED DESCRIPTION OF THE INVENTION

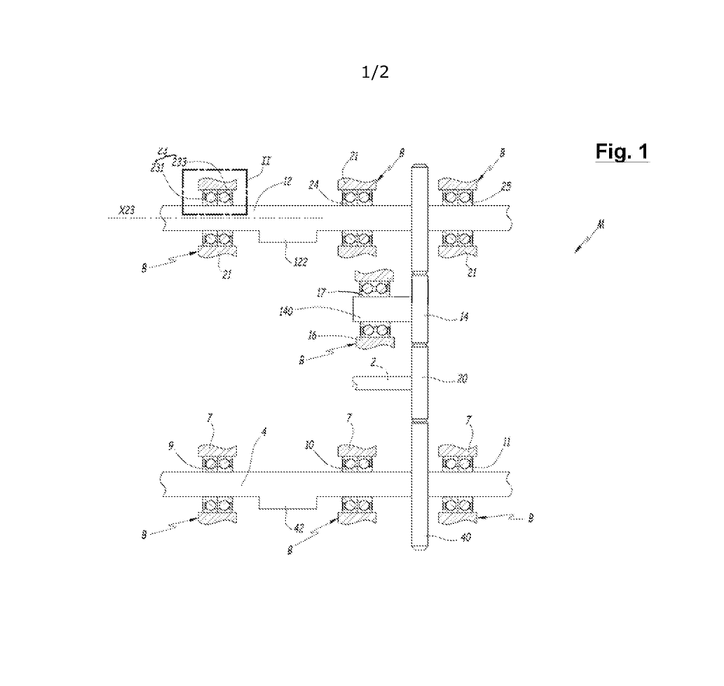

An internal combustion engine M is represented in FIG. 1. The engine M comprises a frame B. The internal combustion engine M comprises a crankshaft 2 of which one end is provided with a toothed wheel 20. The toothed wheel 20 is in engagement with a toothed wheel 40 of a first balance shaft 4, which is freely mounted in rotation in three supports 7 of the frame B. The rotation of the balance shaft 4 in the supports 7 is permitted by two rolling bearings 9 and 10 on a first side of the toothed wheel 40, and a third rolling bearing 11 situated on the other side of the toothed wheel 40 with respect to the rolling bearings 9 and 10.

In this embodiment, the internal combustion engine M comprises a second balance shaft 12, comprising a toothed wheel 120. The balance shaft 12 is freely mounted in rotation in three supports 21 of the frame B. The rotation of the balance shaft 12 is permitted by two rolling bearings 23 and 24 situated on a first side of the toothed wheel 120 and a third rolling bearing 25 situated on the other side of the toothed wheel with respect to the rolling bearings 23 and 24.

The balance shaft 12 is in engagement with a reversing pinion 14, itself in engagement with the toothed wheel 20. The reversing pinion 14 makes it possible for the direction of rotation of the balance shaft 12 to be reversed with respect to the direction of rotation of the balance shaft 4. The reversing pinion 14 comprises a shaft 140 which is freely mounted in rotation in a support 16 of the frame B, via a rolling bearing 17.

The internal combustion engine M is here represented schematically such that the axes of rotation of the balance shafts 4 and 12, of the reversing pinion 14 and of the crankshaft 2 are contained in the same plane in order to make the drawing easier to understand.

In practice, the axes of rotation of the balance shafts 4 and 12, of the reversing pinion 14 and of the crankshaft 2 may be contained in different planes.

Each of the balance shafts 4 and 12 respectively comprises an eccentric mass or unbalance 42 and 122 which makes it possible to obtain the desired compensation for the vibrations due to the movement of the pistons, which are not represented for reasons of clarity.

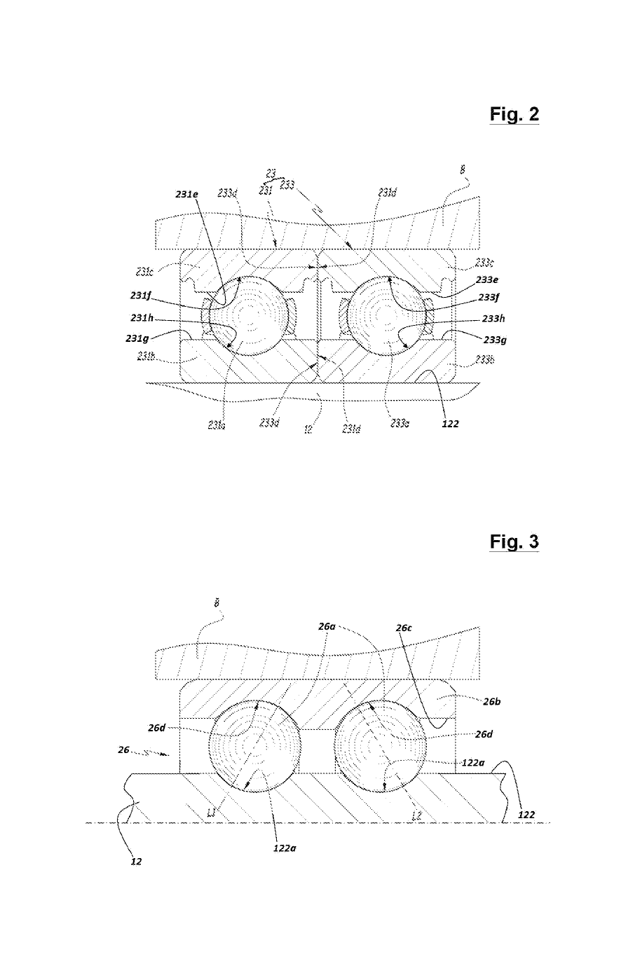

The rolling bearings 9, 10, 11, 23, 24 and 25 are ones having double rows of rolling elements and each consist of two rolling bearings paired with one another and having a single row of rolling elements. Advantageously, the rolling bearings 9, 10, 11, 23, 24 and 25 are lubricated or immersed in a lubricating oil of the internal combustion engine M. For reasons of simplification and clarity, the rolling bearing 23 is represented alone in FIG. 2, the other rolling bearings 9, 10, 11, 24 and 25 being similar. The rolling bearing 23 comprises a first rolling bearing 231 having a single row of rolling elements 231a, in this case balls, and a second rolling bearing 233 having a single row of rolling elements 233a, in this case balls. Each of the rolling bearings 231 and 233 respectively comprises an inner ring 231b, 233b mounted on an outer cylindrical surface 122 of the balance shaft 12 and an outer ring 231c, 233c mounted in the frame B.

The rolling bearings 231 and 233 are joined side by side along an axis of rotation X23, which also corresponds to the longitudinal axis of the rolling bearings 231 and 233. The inner rings 231b, 233b and the outer rings 231c, 233c are joined side by side by a surface contact between lateral faces 233d of the rolling bearing 231 and lateral faces 231d of the rolling bearing 233 which are opposite to the faces 233d.

The outer rings 231c, 233c define an inner bore 231e, 233e provided with a hollow concave portion forming respective outer raceways 231f, 233f for the rolling elements 231a. The inner rings 231b, 233b define an outer cylindrical surface 231g, 233g provided with a hollow concave portion forming respective inner raceways 231h, 233h for the rolling elements 233a.

According to the invention, the raceways 231f, 231h and 233f and 233h of the rolling bearings 231 and 233 respectively are coated with a tungsten sulphide (WS₂) coating. Microcavities formed on and in the tungsten sulphide (WS₂) coating serve as a reservoir for the lubricating oil of the internal combustion engine M. Thus, in the case of the disappearance of the lubricant film between the rolling elements 231a, 233a and one of the raceways 231f, 231h, 233f, 233h respectively, the oil stored in the microcavities of the tungsten sulphide (WS₂) coating provides lubrication between the surfaces of the rolling elements and of the raceway which are in relative sliding contact.

According to a second embodiment represented in FIG. 3, in which identical elements have the same references, a rolling bearing 26 allowing the rotation of the balance shaft 12 differs from the preceding embodiment in that the inner ring of the said rolling bearing 26 and the shaft 12 are formed integrally.

The rolling bearing 26 consists of a single rolling bearing having a double row of rolling elements 26a, in this case balls, and comprises an outer ring 26b mounted in the frame B. The outer ring 26b defines an inner bore 26c provided with two hollow concave portions forming outer raceways 26d for the rolling elements 26a.

The inner ring of the rolling bearing 26 and the shaft 12 are formed integrally. Thus, the balance shaft 12 defines an outer cylindrical surface 122 provided with two hollow concave portions forming inner raceways 122a for the rolling elements 26a.

According to this embodiment, the balls 26a are in oblique contact with the raceways 26d and 122a along oblique contact lines L1 and L2.

According to the invention, the raceways 26d and 122a of the rolling bearing 26 and of the shaft 12 respectively are coated with a tungsten sulphide (WS₂) coating.

According to variants, at least one of the raceways for the rolling elements of at least one of the rolling bearings 9, 10, 11, 16, 17, 23, 24, 25, 26 is coated with the tungsten sulphide (WS₂) coating.

According to one embodiment of the invention which is not shown, the engine M comprises only a single balance shaft. In such a case, the pinion 14 is a follower pinion.

Advantageously, according to a variant which is not shown, at least one of the rolling bearings 9, 10, 11, 16, 17, 23, 24 or 25 may comprise seals which delimit a bearing chamber in which the rolling elements of this rolling bearing are placed. The seals maintain the lubricant, such as an oil, in the bearing chamber, this lubricant being placed in the chamber before the seals are assembled with the inner and outer rings of the rolling bearing.

According to other variants which are not shown, the rolling bearings 9, 10, 11, 16, 17, 23, 24 and 25 may be oblique-contact or radial-contact ball bearings, roller or needle bearings, rolling bearings having a double or single row, a single rolling bearing or a plurality of rolling bearings paired with one another, or rolling bearings of types which differ from one another without departing from the scope of the present invention.

The technical features of the embodiments and variants envisaged above may be combined with one another.

1. A rolling bearing comprising:
at least one row of rolling elements disposed between an inner raceway and an outer raceway, wherein
at least one of the raceways is coated with a tungsten sulphide (WS₂) coating.

2. The rolling bearing according to claim 1, further comprising an outer ring having a substantially cylindrical inner bore providing at least one raceway for the rolling elements.

3. The rolling bearing according to claim 1, further comprising an inner ring having a substantially cylindrical outer surface providing at least one raceway for the rolling elements.

4. The rolling bearing according to claim 1, further comprising being immersed in a lubricant.

5. The rolling bearing according to claim 1, wherein the tungsten sulphide (WS₂) coating of at least one raceway is formed by crystals of tungsten sulphide (WS₂), known as tungsten disulphide.

6. The rolling bearing according to claim 5, wherein the crystals of the tungsten sulphide (WS₂) coating have a crystalline diameter of between 0.8 and 1.5 μm and a thickness of at most 100 nm.

7. The rolling bearing according to claim 1, wherein the thickness of the tungsten sulphide (WS₂) coating is between 0.5 and 0.8 μm.

8. An internal combustion engine (M) comprising:
at least one balance shaft rotated by a crankshaft of the internal combustion engine (M), the at least one balance shaft being freely supported in rotation in a frame (B) of the internal combustion engine (M) by at least one rolling bearing having at least one row of rolling elements disposed between an inner raceway and an outer raceway, wherein
at least one of the raceways is coated with a tungsten sulphide (WS₂) coating.

9. The internal combustion engine according to claim 8, wherein the at least one rolling bearing supporting the at least one balance shaft includes an outer ring fixedly mounted in the frame (B) and an inner ring mounted on the balance shaft.

10. The internal combustion engine according to claim 8, wherein the at least one rolling bearing supporting the at least one balance shaft includes an outer ring fixedly mounted in the frame (B) and the at least one balance shaft is provided with an outer cylindrical surface of which a portion is substantially cylindrical and has at least one raceway for the rolling elements of the at least one rolling bearing.
